(19) United States
(12) Patent Application Publication
(10) Pub. No.: US 2024/0142071 A1
(43) Pub. Date: May 2, 2024

(54) COMBINATION LIGHT STRING

(71) Applicant: Ming Li, Shenzhen (CN)

(72) Inventor: Ming Li, Shenzhen (CN)

(21) Appl. No.: 17/983,542

(22) Filed: Nov. 9, 2022

(30) Foreign Application Priority Data
Oct. 31, 2022 (CN) 202222891842.3

(51) Int. Cl. F21S 4/10; F21V 33/00; H05B 47/155

(52) U.S. Cl. CPC F21S 4/10; F21V 33/0056; H05B 47/155; F21Y 2115/10

(57) ABSTRACT

The invention discloses a combination light string, comprising: line lamps, wherein a plurality of the line lamps are respectively connected in parallel on an electric wire; bulb lamps, wherein a plurality of the bulb lamps are respectively connected in parallel on the electric wire, and the bulb lamps are connected in series with the line lamps; control units, which are respectively connected to each of the line lamps and each of the bulb lamps; at least one bulb lamp is provided between any adjacent two line lamps; the control unit can individually control the working states of all the line lamps, and the control unit can individually control the working states of the bulb lamps, so as to realize the control of each of the line lamps and each of the bulb lamps.

### 1. TECHNICAL FIELD

The invention relates to the technical field of light strings, in particular to a combination light string.

### 2. BACKGROUND ART

As the largest product in the European and American traditional Christmas lighting market, the light string is generally a whole line of pure line lamps, or a whole light body with a lampshade, and the form is relatively simple; the whole light string can only be controlled in a unified way, that is, the control command issued by the controller acts on the entire light string to control the working state of the entire light string. When multiple lamp bodies are combined in a light string, the independent control of a single lamp body cannot be realized, the segment control of the lamp body of a certain lamp segment cannot be realized, and the group control of any combination of lamp groups cannot be realized, etc., as a result, either the form of the light string is single, or the complex control cannot be realized for the light string with complex form. Therefore, it is necessary to provide a combination light string, so as to avoid the single form of the light string and the inability to realize complex control of the light string with complex form.

### 3. Summary of the Invention

The purpose of the invention is to provide a combination light string, so as to avoid the single form of the light string and the inability to realize complex control of the light string with complex form.

According to an aspect of the invention, a combination light string is provided, comprising:
line lamps, wherein a plurality of the line lamps are respectively connected in parallel on an electric wire;
bulb lamps, wherein a plurality of the bulb lamps are respectively connected in parallel on the electric wire, and the bulb lamps are connected in series with the line lamps;
control units, which are respectively connected to each of the line lamps and each of the bulb lamps; at least one bulb lamp is provided between any adjacent two line lamps; the control unit can individually control the working states of all the line lamps, and the control unit can individually control the working states of the bulb lamps.

Preferably, the line lamp comprises: a first lamp bead connected in parallel with the electric wire;
the bulb lamp comprises: a second lamp bead connected in parallel with the electric wire and in series with the first lamp bead, and a lampshade provided on the second lamp bead;
both the first lamp bead and the second lamp bead comprise:
an LED illuminant, which is connected to the electric wire;
driver chips, which are respectively connected to the LED illuminant and the control unit;
   the control unit sends a control signal to the driver chip, and the driver chip controls the working state of the LED illuminant according to the control signal.

Preferably, any number of line lamps and/or any number of bulb lamps are configured as a first lamp group, and any number of the remaining line lamps and/or any number of the remaining bulb lamps are configured as a Nth lamp group; the control unit can individually control the working state of the first lamp group, and the control unit can independently control the working state of the Nth lamp group.

Preferably, the control unit is integrated in a controller, and the control unit comprises:
a color adjustment module, wherein the color adjustment module is respectively connected to each of the line lamps and each of the bulb lamps, and the color adjustment module adjusts the color of each of the line lamps and each of the bulb lamps; the color adjustment module is respectively connected to each of the driver chips; the color adjustment module sends a color adjustment instruction to each of the driver chips, and the driver chip controls the color of each of the LED illuminants according to the color adjustment instruction.

Preferably, the control unit further comprises:
a brightness adjustment module, wherein the brightness adjustment module is respectively connected to each of the line lamps and each of the bulb lamps, and the brightness adjustment module adjusts the brightness of each of the line lamps and each of the bulb lamps; the brightness adjustment module is respectively connected to each of the driver chips; the brightness adjustment module sends a brightness adjustment instruction to each of the driver chips, and the driver chip controls the brightness of each of the LED illuminants according to the brightness adjustment instruction.

Preferably, the control unit further comprises:
a flickering speed regulation module, wherein the flickering speed regulation module is respectively connected to each of the line lamps and each of the bulb lamps, and the flickering speed regulation module adjusts the flickering speed of each of the line lamps and each of the bulb lamps; the flickering speed regulation module is respectively connected to each of the driver chips; the flickering speed regulation module sends a flickering speed regulation instruction to each of the driver chips, and the driver chip controls the flickering speed of each of the LED illuminants according to the flickering speed regulation instruction.

Preferably, the control unit further comprises:
a scene control module, which is respectively connected to the color adjustment module, the brightness adjustment module, and the flickering speed regulation module by signal; the scene control module stores preset scene color adjustment instructions, scene brightness adjustment instructions, and scene flickering speed regulation instructions; the scene control module respectively sends the preset scene color adjustment instructions to the color adjustment module, sends the preset scene brightness adjustment instructions to the brightness adjustment module, and sends the preset scene flickering speed regulation instructions to the flickering speed regulation module; the color adjustment module sends the scene color adjustment instruction to each of the driver chips, and the driver chip controls the color of each of the LED illuminants according to the scene color adjustment instruction; the brightness adjustment module sends the scene brightness adjustment instruction to each of the driver chips, and the driver chip controls the brightness of each of the LED illuminants according to the scene brightness adjustment instruction; the flickering speed regulation module sends the scene flickering speed regulation instruction to each of the driver chips, and the driver chip controls the flickering speed of each of the LED illuminants according to the scene flickering speed regulation instruction.

Preferably, the control unit further comprises:
a music rhythm module, which is respectively connected to the color adjustment module, the brightness adjustment module, and the flickering speed regulation module by signal; the controller collects the sound intensity of surrounding sounds, and converts sound signals with different sound intensities into different digital signals;
the music rhythm module stores multiple preset rhythm color adjustment instructions, multiple preset rhythm brightness adjustment instructions, and multiple preset rhythm flickering speed regulation instructions; the music rhythm module invokes different rhythm color adjustment instructions, rhythm brightness adjustment instructions, and rhythm flickering speed regulation instructions according to different digital signals, and respectively sends the rhythm color adjustment instructions to the color adjustment module, sends the rhythm brightness adjustment instructions to the brightness adjustment module, and sends the rhythm flickering speed regulation instructions to the flickering speed regulation module; the color adjustment module sends the rhythm color adjustment instruction to each of the driver chips, and the driver chip controls the color of each of the LED illuminants according to the rhythm color adjustment instruction; the brightness adjustment module sends the rhythm brightness adjustment instruction to each of the driver chips, and the driver chip controls the brightness of each of the LED illuminants according to the rhythm brightness adjustment instruction; the flickering speed regulation module sends the flickering speed regulation instruction to each of the driver chips, and the driver chip controls the flickering speed of each of the LED illuminants according to the rhythm flickering speed regulation instruction.

Preferably, the controller comprises: one or a combination of a Bluetooth mobile control terminal, an infrared controller, and a key controller.

Preferably, the controller further comprises:
a microphone, which is used to collect surrounding sound information;
a processing chip, which converts the sound information collected by the microphone into digital signals, and classifies the sound information according to the sound intensity in the sound information; different levels of sound information correspond to different rhythm color adjustment instructions, different rhythm brightness adjustment instructions, and different rhythm flickering speed regulation instructions.

The invention has the following advantageous effects:
The invention realizes more abundant light string configuration forms by connecting a plurality of line lamps in parallel with the wires respectively, and setting a plurality of light plates connected in series with the line lamps; the control unit is respectively connected to each of the line lamps and each of the bulb lamps, so as to realize the control of each of the line lamps and each of the bulb lamps; at least one bulb lamp is provided between any adjacent two line lamps; the control unit can individually control the working states of all the line lamps, and the control unit can individually control the working states of the bulb lamps, thereby realizing flexible control of complex light string combinations.

### 4. BRIEF DESCRIPTION OF ACCOMPANY DRAWINGS

In order to explain the embodiments of the invention or the technical solutions in the prior art more clearly, the drawings that need to be used in the description of the embodiments or the prior art will be introduced hereinafter. Obviously, the drawings in the following description are only some embodiments of the invention. For those of ordinary skill in the art, other drawings may be obtained from these drawings without creative efforts.

FIG. 1 is a schematic three-dimensional structure diagram of the light string according to an embodiment of the invention;

FIG. 2 is another schematic three-dimensional structure diagram of the light string according to an embodiment of the invention;

FIG. 3 is a further schematic three-dimensional structure diagram of the light string according to an embodiment of the invention;

FIG. 4 is another further schematic three-dimensional structure diagram of the light string according to an embodiment of the invention;

FIG. 5 is a structural block diagram of the light string according to an embodiment of the invention;

FIG. 6 is a structural block diagram of the first lamp bead and the second lamp bead according to an embodiment of the invention;

FIG. 7 is a connection block diagram of the control unit according to an embodiment of the invention;

FIG. 8 is a connection block diagram of the controller according to an embodiment of the invention;

Description of reference numbers: 100 refers to the combination light string; 10 refers to the line lamp; 20 refers to the bulb lamp; 30 refers to the control unit; 11 refers to the first lamp bead; 21 refers to the second lamp bead; 22 refers to the lampshade; 110 refers to the LED illuminant; 120 refers to the driver chip; 40 refers to the controller; 31 refers to the color adjustment module; 32 refers to the brightness adjustment module; 33 refers to the flickering speed regulation module; 34 refers to the scene control module; 35 refers to the music rhythm module; 41 refers to the Bluetooth mobile control terminal; 42 refers to the infrared controller; 43 refers to the key controller; 44 refers to the microphone; 45 refers to the processing chip.

### 5. SPECIFIC EMBODIMENT OF THE INVENTION

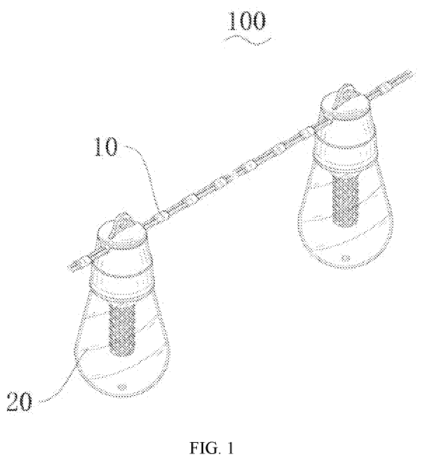

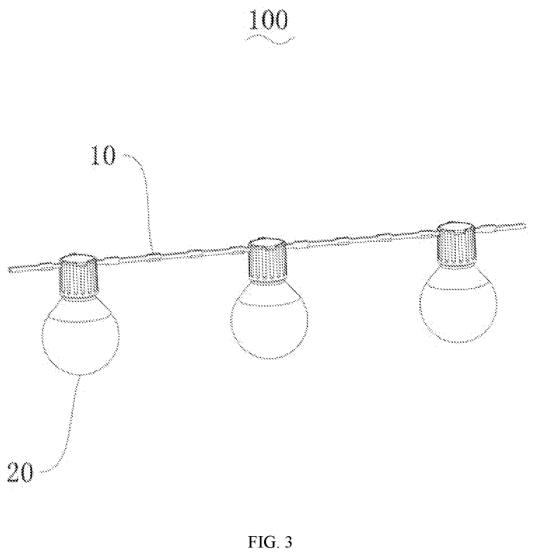

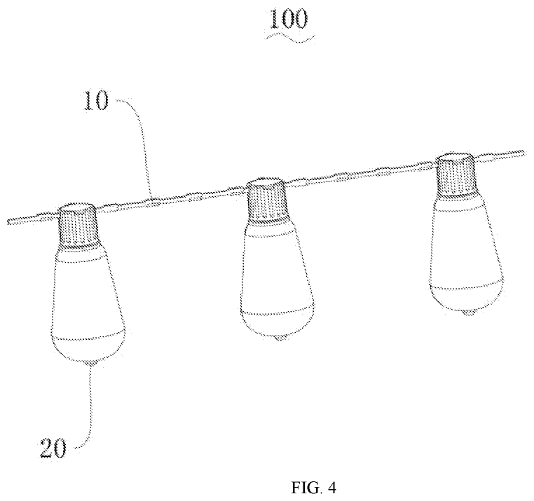

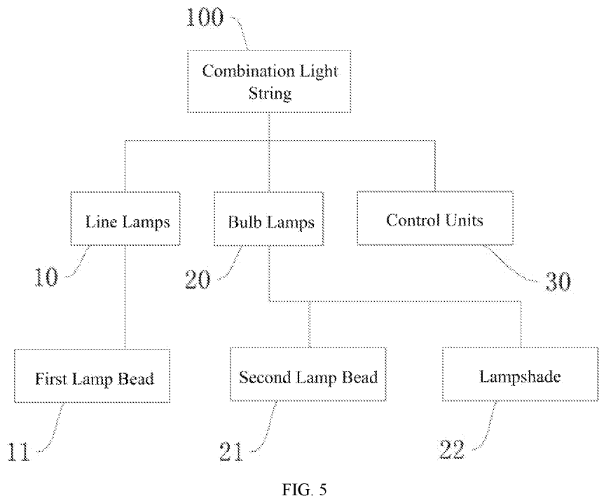

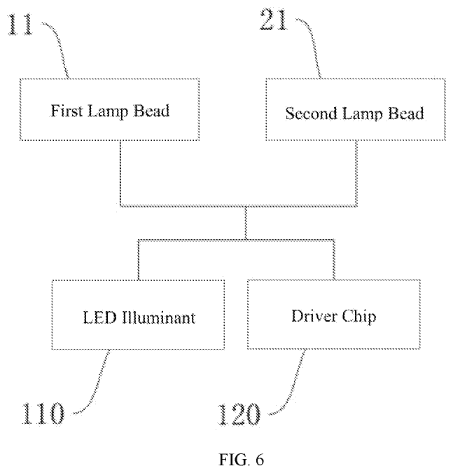

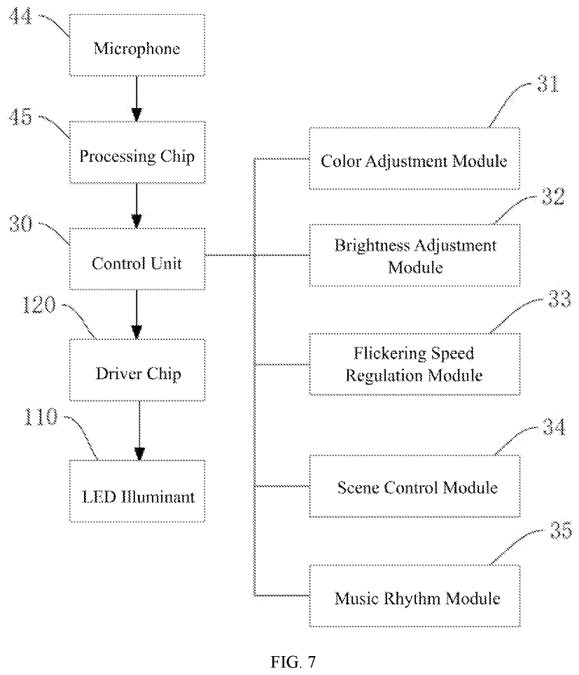

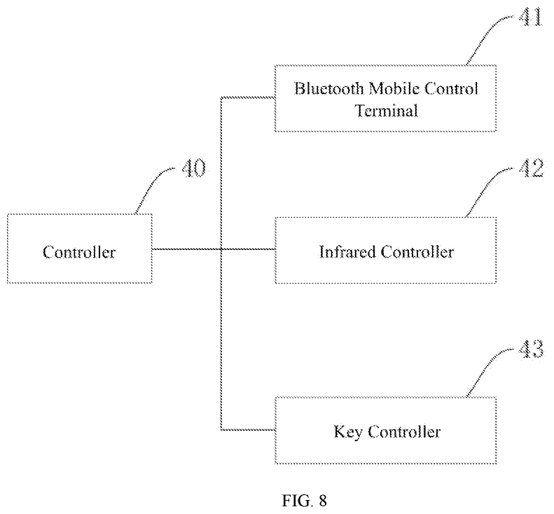

With reference to FIG. 1-FIG. 8, an embodiment of the invention provides a combination light string 100, comprising: line lamps 10, bulb lamps 20, and control units 30.

A plurality of the line lamps 10 are respectively connected in parallel on an electric wire; a plurality of the bulb lamps 20 are respectively connected in parallel on the electric wire, and the bulb lamps 20 are connected in series with the line lamps 10; therefore, it is different from the traditional light string that there are only the line lamps 100, or only the single form of the bulb lamps 20, which makes the light string more abundant.

The control units 30 are respectively connected to each of the line lamps 10 and each of the bulb lamps 20, so as to realize electronic control of each of the line lamps 10 and each of the bulb lamps 20.

At least one bulb lamp 20 is provided between any adjacent two line lamps 10, so as to form a more complex combination of line lamps 10 and bulb lamps 20, which can be that: one or more bulb lamps 20 may be provided between the two line lamps 10, or one or more line lamps 10 may be provided between the two bulb lamps 20, or different numbers of bulb lamps 20 may also be provided between any two line lamps 10, or different numbers of line lamps 10 may be provided between any two bulb lamps 20. With reference to FIG. 1, in the embodiment, six line lamps 10 are provided between two bulb lamps 20, and the number of line lamps 10 between any two bulb lamps 20 is the same; the control unit 30 can individually control the working states of all the line lamps 10, and the control unit 30 can individually control the working states of the bulb lamps 20, that is, the control unit 30 can control the working states of two bulb lamps 20 independently, and can also control the working states of the six line lamps 10 independently, thereby making the control mode of the light string more flexible and rich.

In one embodiment, the line lamp 10 comprises: a first lamp bead 11 connected in parallel with the electric wire. The bulb lamp 20 comprises: a second lamp bead 21 connected in parallel with the electric wire and in series with the first lamp bead 11, and a lampshade 22 provided on the second lamp bead 21. Both the first lamp bead 11 and the second lamp bead 21 comprise: an LED illuminant 110 and driver chips 120.

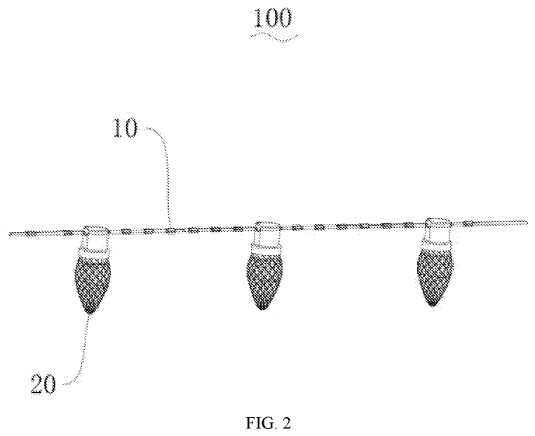

The lampshade 22 may be the strawberry lampshade 22 structure as shown in FIG. 2, or other lampshade 22 structures as shown in FIGS. 1, 3, and 4. The lampshade 22 may be a partially transparent or completely transparent lampshade 22.

The LED illuminant 110 is connected to the electric wire; the driver chips 120 are respectively connected to the LED illuminant 110 and the control unit 30; the control unit 30 sends a control signal to the driver chip 120, and the driver chip 120 controls the working state of the LED illuminant 110 according to the control signal. Equivalently, the line lamps 10 and the bulb lamps 20 can adapt the same lamp beads. In production practice, a string of pure line lamps 10 can be purchased, and the bulb lamps 20 can be obtained by adding a lampshade 22 to any line lamp 10 on the string of pure line lamps 10. Since the control unit 30 can control each lamp bead, the line lamps 10 and the bulb lamps 20 can be combined in any form to obtain a more colorful combination effect.

For example, any number of line lamps 10 and/or any number of bulb lamps 20 are configured as a first lamp group, and any number of the remaining line lamps 10 and/or any number of the remaining bulb lamps 20 are configured as a Nth lamp group; the control unit 30 can individually control the working state of the first lamp group, and the control unit 30 can independently control the working state of the Nth lamp group, thereby realizing group control of the light string. For another example, the segmental control of all the line lamps 10 and all the bulb lamps 20 in any section greatly enriches the control mode of the light string.

In the embodiment, the LED illuminant 110 is formed by three primary colors of RGB, which can be RGB three-color lamp beads or RGBW four-color lamp beads. In this embodiment, the LED illuminant 110 is an RGB three-color lamp bead. The outside of the lamp bead is encapsulated by fog-like colloid. Each lamp bead on the light string has its own address code, and all the lamp beads are connected in parallel. The signal lines are connected in parallel through the bus; due to this connection method and the address code, the lamp string of this method will not affect the normal use of other lamp beads if a certain lamp bead is damaged; in addition, since each lamp bead has its own address code, the controller 40 can control each lamp bead according to the address code, and can realize the display of complex combination of lamp beads; the driver chip 120 adopts a single-wire communication mode, and adopts a return-to-zero code mode to send signals. After the chip is powered on and reset, the chip signal pin receives the data sent by the controller 40; after receiving the fixed-length data, the chip performs data analysis according to the defined relevant protocol, controls the built-in RGB three-color lamp beads or RGBW four-color lamp beads through the IO port, and controls the gray levels of the R, G, B monochromatic lamp beads through PWM signals (each lamp bead has 256 gray levels) to mix 16777216 colors. The controller 40 divides the brightness of the lamp beads into 1000 levels, and can realize the brightness adjustment of 1000 levels. After processing the data sent by the controller 40, the chip waits to receive new data again. After receiving the initial data, the original outputs of the R, G, and B pins remain unchanged before the chip receives the RESET signal. The controller 40 can control the display color, brightness, and refresh interval of the lamp beads (i.e., the timing of flickering) according to the requirements of various scenarios.

The driver chip 120 is electrically connected to the LED illuminant 110, and is connected the control unit 30 by signal; the control unit 30 sends a control signal to the driver chip 120, and the driver chip 120 controls the working state of the LED illuminant 110 according to the control signal. The working state includes the switch, brightness, color, flickering timing, etc. of the LED illuminant 110. One working state can be controlled alone, or multiple working states can be combined into a set of preset programs to execute repeatedly; for example, multiple scene modes are preset, and different scene modes correspond to different brightness of the LED illuminators 110, different colors of the LED illuminators 110, and different flickering timings of the LED illuminators 110, so as to construct a customized control scene.

In one embodiment, the control unit 30 is integrated in a controller 40, and the control unit 30 comprises: a color adjustment module 31, a brightness adjustment module 32, a flickering speed regulation module 33, a scene control module 34, and a music rhythm module 35.

The color adjustment module 31 is respectively connected to each of the line lamps 10 and each of the bulb lamps 20, and the color adjustment module 31 adjusts the color of each of the line lamps 10 and each of the bulb lamps 20; the color adjustment module 31 is respectively connected to each of the driver chips 120; the color adjustment module 31 sends a color adjustment instruction to each of the driver chips 120, and the driver chip 120 controls the color of each of the LED illuminants 110 according to the color adjustment instruction.

The brightness adjustment module 32 is respectively connected to each of the line lamps 10 and each of the bulb lamps 20, and the brightness adjustment module 32 adjusts the brightness of each of the line lamps 10 and each of the bulb lamps 20; the brightness adjustment module 32 is respectively connected to each of the driver chips 120; the brightness adjustment module 32 sends a brightness adjustment instruction to each of the driver chips 120, and the driver chip 120 controls the brightness of each of the LED illuminants 110 according to the brightness adjustment instruction.

The flickering speed regulation module 33 is respectively connected to each of the line lamps 10 and each of the bulb lamps 20, and the flickering speed regulation module 33 adjusts the flickering speed of each of the line lamps 10 and each of the bulb lamps 20; the flickering speed regulation module 33 is respectively connected to each of the driver chips 120; the flickering speed regulation module 33 sends a flickering speed regulation instruction to each of the driver chips 120, and the driver chip 120 controls the flickering speed of each of the LED illuminants 110 according to the flickering speed regulation instruction.

The scene control module 34 is respectively connected to the color adjustment module 31, the brightness adjustment module 32, and the flickering speed regulation module 33 by signal; the scene control module 34 stores preset scene color adjustment instructions, scene brightness adjustment instructions, and scene flickering speed regulation instructions; the scene control module 34 respectively sends the preset scene color adjustment instructions to the color adjustment module 31, sends the preset scene brightness adjustment instructions to the brightness adjustment module 32, and sends the preset scene flickering speed regulation instructions to the flickering speed regulation module 33; the color adjustment module 31 sends the scene color adjustment instruction to each of the driver chips 120, and the driver chip 120 controls the color of each of the LED illuminants 110 according to the scene color adjustment instruction; the brightness adjustment module 32 sends the scene brightness adjustment instruction to each of the driver chips 120, and the driver chip 120 controls the brightness of each of the LED illuminants 110 according to the scene brightness adjustment instruction; the flickering speed regulation module 33 sends the scene flickering speed regulation instruction to each of the driver chips 120, and the driver chip 120 controls the flickering speed of each of the LED illuminants 110 according to the scene flickering speed regulation instruction.

The music rhythm module 35 is respectively connected to the color adjustment module 31, the brightness adjustment module 32, and the flickering speed regulation module 33 by signal; the controller 40 collects the sound intensity of surrounding sounds, and converts sound signals with different sound intensities into different digital signals;

The music rhythm module 35 stores multiple preset rhythm color adjustment instructions, multiple preset rhythm brightness adjustment instructions, and multiple preset rhythm flickering speed regulation instructions; the music rhythm module 35 invokes different rhythm color adjustment instructions, rhythm brightness adjustment instructions, and rhythm flickering speed regulation instructions according to different digital signals, and respectively sends the rhythm color adjustment instructions to the color adjustment module 31, sends the rhythm brightness adjustment instructions to the brightness adjustment module 32, and sends the rhythm flickering speed regulation instructions to the flickering speed regulation module 33; the color adjustment module 31 sends the rhythm color adjustment instruction to each of the driver chips 120, and the driver chip 120 controls the color of each of the LED illuminants 110 according to the rhythm color adjustment instruction; the brightness adjustment module 32 sends the rhythm brightness adjustment instruction to each of the driver chips 120, and the driver chip 120 controls the brightness of each of the LED illuminants 110 according to the rhythm brightness adjustment instruction; the flickering speed regulation module 33 sends the flickering speed regulation instruction to each of the driver chips 120, and the driver chip 120 controls the flickering speed of each of the LED illuminants 110 according to the rhythm flickering speed regulation instruction.

In the embodiment, a plurality of preset rhythm color adjustment instructions, a plurality of preset rhythm brightness adjustment instructions, and a plurality of preset rhythm flickering speed regulation instructions stored in the music rhythm module 35 correspond to four music rhythm modes respectively, namely, energy mode, rhythm mode, spectrum mode, and rolling mode. The energy mode: after the light string is lit in cycles with seven colors of red, orange, yellow, green, blue, cyan and purple, the brightness of the light string is changed according to the sound level, and the light is turned off when there is no sound. Rhythm mode: when a sound change is detected, the light string will be lit with seven colors of red, orange, yellow, green, blue, cyan and purple cyclically and moved to the right; the brightness of the light string will change according to the sound level; when there is no sound, the light string will automatically enter a monochrome breathing state. Spectrum mode: the light string is lit from the middle to both sides, and the number of lighted bulbs is controlled according to the sound level to achieve a spectrum-like effect. Rolling mode: for every three lights in a group, the brightness decreases in turn; during the sound change process, the color of each light bead on the light string is cyclically shifted to the previous light to achieve a rolling effect.

In one embodiment, the controller 40 comprises: one or a combination of a Bluetooth mobile control terminal 41, an infrared controller 42, and a key controller 43. In this embodiment, the controller 40 further comprises a Bluetooth mobile control terminal 41, an infrared controller 42, and a key controller 43; the control unit 30 is integrated into the Bluetooth mobile control terminal 41, the infrared controller 42, and the key controller 43, respectively.

Specifically, the controller 40 further comprises: a microphone 44 and a processing chip 45.

The microphone 44 is used to collect surrounding sound information; the processing chip 45 is connected to the control unit 30, and converts the sound information collected by the microphone 44 into digital signals, and classifies the sound information according to the sound intensity in the sound information; different levels of sound information correspond to different rhythm color adjustment instructions, different rhythm brightness adjustment instructions, and different rhythm flickering speed regulation instructions.

The Bluetooth mobile control terminal 41 can establish a wireless connection with the driver chip 120 through Bluetooth and other mobile communication devices such as mobile phones and tablet computers. In the embodiment, the Bluetooth mobile control terminal is a mobile phone, the control unit 30 is an APP integrated on the mobile phone, and the light string 100 is controlled through a visual operation interface on the APP. The Bluetooth mobile control terminal 41 is provided with a microphone 44, and the sound intensity of the surrounding sound is collected through the microphone 44. The processing chip 45 in the Bluetooth mobile control terminal 41 converts the sound (i.e., analog signal) collected by the microphone 44 into a digital signal, so that the sound level can be classified. Different music modes make colorful changes according to the sound level.

The processing chip 45 adopts a conventional processing chip 45 that converts an analog signal representing sound information into a digital signal, and integrates an algorithm that can be classified according to the size of the sound intensity in the sound information, for example, the sound is divided into N levels according to the frequency of the sound, each level corresponds to a corresponding frequency segment, and each level corresponds to a specific preset instruction in the music rhythm module 35. The preset instructions include preset rhythmic color adjustment instructions, preset rhythmic brightness adjustment instructions, and preset rhythmic flickering speed regulation instructions. Thereby, different colorful effects are presented according to the sound intensity of the sound.

The infrared controller 42 establishes a wireless connection with the light string through infrared. The infrared controller 42 and the key controller 43 are further provided with a microphone 44 and a processing chip 45, and the principle of their acting on the music rhythm module 35 is the same as that of the microphone 44 and the processing chip 45 in the Bluetooth mobile control terminal 41.

The infrared controller 42 has a built-in infrared receiving device, and the outer casing of the controller 40 is made of infrared light-transmitting material. The control signal of the infrared remote control can pass through the casing, receive the infrared signal through the infrared receiving device on the controller 40, and decode the key value through the NEC protocol software; the key functions are correspondingly realized through the preset key values, and the control of switch, color selection, brightness adjustment, timing, mode selection, music mode sensitivity adjustment, etc. is realized.

The key controller 43 refers to realizing the input of instructions to the control unit 30 through mechanical keys, and the triggering of the keys and the input of the instructions may adopt conventional means in the art.

The invention realizes more abundant light string configuration forms by connecting a plurality of line lamps 10 in parallel with the wires respectively, and setting a plurality of light plates connected in series with the line lamps 10; the control unit 30 is respectively connected to each of the line lamps 10 and each of the bulb lamps 20, so as to realize the control of each of the line lamps 10 and each of the bulb lamps 20; at least one bulb lamp 20 is provided between any adjacent two line lamps 10; the control unit 30 can individually control the working states of all the line lamps 10, and the control unit 30 can individually control the working states of the bulb lamps 20, thereby realizing flexible control of complex light string combinations.

1. A combination light string, comprising:
line lamps, wherein a plurality of the line lamps are respectively connected in parallel on an electric wire;
bulb lamps, wherein a plurality of the bulb lamps are respectively connected in parallel on the electric wire, and the bulb lamps are connected in series with the line lamps;
control units, which are respectively connected to each of the line lamps and each of the bulb lamps; at least one bulb lamp is provided between any adjacent two line lamps; the control unit can individually control the working states of all the line lamps, and the control unit can individually control the working states of the bulb lamps.

2. The combination light string of claim 1, wherein:
the line lamp comprises: a first lamp bead connected in parallel with the electric wire;
the bulb lamp comprises: a second lamp bead connected in parallel with the electric wire and in series with the first lamp bead, and a lampshade provided on the second lamp bead;
both the first lamp bead and the second lamp bead comprise:
an LED illuminant, which is connected to the electric wire;
driver chips, which are respectively connected to the LED illuminant and the control unit; the control unit sends a control signal to the driver chip, and the driver chip controls the working state of the LED illuminant according to the control signal.

3. The combination light string of claim 1, wherein:
any number of line lamps and/or any number of bulb lamps are configured as a first lamp group, and any number of the remaining line lamps and/or any number of the remaining bulb lamps are configured as a Nth lamp group; the control unit can individually control the working state of the first lamp group, and the control unit can independently control the working state of the Nth lamp group.

4. The combination light string of claim 1, wherein the control unit is integrated in a controller, and the control unit comprises:
a color adjustment module, wherein the color adjustment module is respectively connected to each of the line lamps and each of the bulb lamps, and the color adjustment module adjusts the color of each of the line lamps and each of the bulb lamps; the color adjustment module is respectively connected to each of the driver chips; the color adjustment module sends a color adjustment instruction to each of the driver chips, and the driver chip controls the color of each of the LED illuminants according to the color adjustment instruction.

5. The combination light string of claim 4, wherein the control unit further comprises:
a brightness adjustment module, wherein the brightness adjustment module is respectively connected to each of the line lamps and each of the bulb lamps, and the brightness adjustment module adjusts the brightness of each of the line lamps and each of the bulb lamps; the brightness adjustment module is respectively connected to each of the driver chips; the brightness adjustment module sends a brightness adjustment instruction to each of the driver chips, and the driver chip controls the brightness of each of the LED illuminants according to the brightness adjustment instruction.

6. The combination light string of claim 5, wherein the control unit further comprises:
a flickering speed regulation module, wherein the flickering speed regulation module is respectively connected to each of the line lamps and each of the bulb lamps, and the flickering speed regulation module adjusts the flickering speed of each of the line lamps and each of the bulb lamps; the flickering speed regulation module is respectively connected to each of the driver chips; the flickering speed regulation module sends a flickering speed regulation instruction to each of the driver chips, and the driver chip controls the flickering speed of each of the LED illuminants according to the flickering speed regulation instruction.

7. The combination light string of claim 6, wherein the control unit further comprises:
a scene control module, which is respectively connected to the color adjustment module, the brightness adjustment module, and the flickering speed regulation module by signal; the scene control module stores preset scene color adjustment instructions, scene brightness adjustment instructions, and scene flickering speed regulation instructions; the scene control module respectively sends the preset scene color adjustment instructions to the color adjustment module, sends the preset scene brightness adjustment instructions to the brightness adjustment module, and sends the preset scene flickering speed regulation instructions to the flickering speed regulation module; the color adjustment module sends the scene color adjustment instruction to each of the driver chips, and the driver chip controls the color of each of the LED illuminants according to the scene color adjustment instruction; the brightness adjustment module sends the scene brightness adjustment instruction to each of the driver chips, and the driver chip controls the brightness of each of the LED illuminants according to the scene brightness adjustment instruction; the flickering speed regulation module sends the scene flickering speed regulation instruction to each of the driver chips, and the driver chip controls the flickering speed of each of the LED illuminants according to the scene flickering speed regulation instruction.

8. The combination light string of claim 6, wherein the control unit further comprises:
a music rhythm module, which is respectively connected to the color adjustment module, the brightness adjustment module, and the flickering speed regulation module by signal; the controller collects the sound intensity of surrounding sounds, and converts sound signals with different sound intensities into different digital signals;
the music rhythm module stores multiple preset rhythm color adjustment instructions, multiple preset rhythm brightness adjustment instructions, and multiple preset rhythm flickering speed regulation instructions; the music rhythm module invokes different rhythm color adjustment instructions, rhythm brightness adjustment instructions, and rhythm flickering speed regulation instructions according to different digital signals, and respectively sends the rhythm color adjustment instructions to the color adjustment module, sends the rhythm brightness adjustment instructions to the brightness adjustment module, and sends the rhythm flickering speed regulation instructions to the flickering speed regulation module; the color adjustment module sends the rhythm color adjustment instruction to each of the driver chips, and the driver chip controls the color of each of the LED illuminants according to the rhythm color adjustment instruction; the brightness adjustment module sends the rhythm brightness adjustment instruction to each of the driver chips, and the driver chip controls the brightness of each of the LED illuminants according to the rhythm brightness adjustment instruction; the flickering speed regulation module sends the flickering speed regulation instruction to each of the driver chips, and the driver chip controls the flickering speed of each of the LED illuminants according to the rhythm flickering speed regulation instruction.

9. The combination light string of claim 8, wherein the controller comprises: one or a combination of a Bluetooth mobile control terminal, an infrared controller, and a key controller.

10. The combination light string of claim 9, wherein the controller further comprises:
a microphone, which is used to collect surrounding sound information;
a processing chip, which converts the sound information collected by the microphone into digital signals, and classifies the sound information according to the sound intensity in the sound information; different levels of sound information correspond to different rhythm color adjustment instructions, different rhythm brightness adjustment instructions, and different rhythm flickering speed regulation instructions.
